(19) United States
(12) Patent Application Publication
(10) Pub. No.: US 2011/0164430 A1
(43) Pub. Date: Jul. 7, 2011

(54) Illuminator using light emitting diode light recycling with collimation

(76) Inventor: Kenneth Li, Castaic, CA (US)

(21) Appl. No.: 12/930,427

(22) Filed: Jan. 6, 2011

Related U.S. Application Data
(60) Provisional application No. 61/296,171, filed on Jan. 19, 2010.
(60) Provisional application No. 61/292,949, filed on Jan. 7, 2010.

(51) Int. Cl. G02B 6/00; F21V 7/00; G02B 27/20

(52) U.S. Cl. 362/551; 362/308; 362/235; 362/259

(57) ABSTRACT

The invention provides for an illuminator device. The device includes a light emitting means, such as an LED with a white phosphor, a waveguide or light directing and reflecting means which has an output means for release of light, and a lens system. The device may be formatted as a flashlight device. Preferably, the LED emits blue light, and the waveguide is at least partially coated to enhance reflectance.

### CROSS-REFERENCE TO RELATED APPLICATIONS

This application claims priority from provisional application Ser. Nos. 61/296,171 filed Jan. 19, 2010 and 61,292,949 filed Jan. 7, 2010, both of which are incorporated by reference.

### SUMMARY OF THE INVENTION

The invention relates to illuminators using light emitting diodes (“LED” hereafter), light recycling with collimation, such as flashlights, which employ, e.g., white phosphor as part of the light generating means.

### BRIEF DESCRIPTION OF THE FIGURES

FIG. 1 shows an embodiment of the invention in its broadest form.

FIG. 2 depicts an embodiment of the invention where a reflective recycling collar is used.

FIG. 3 shows an embodiment where a single piece “reflective bullet” replaces the collar of FIG. 2.

FIGS. 4 and 5 depict modifications of FIGS. 2 and 3 where a laser is used to intensify light output.

### DETAILED DESCRIPTION OF THE PREFERRED EMBODIMENTS

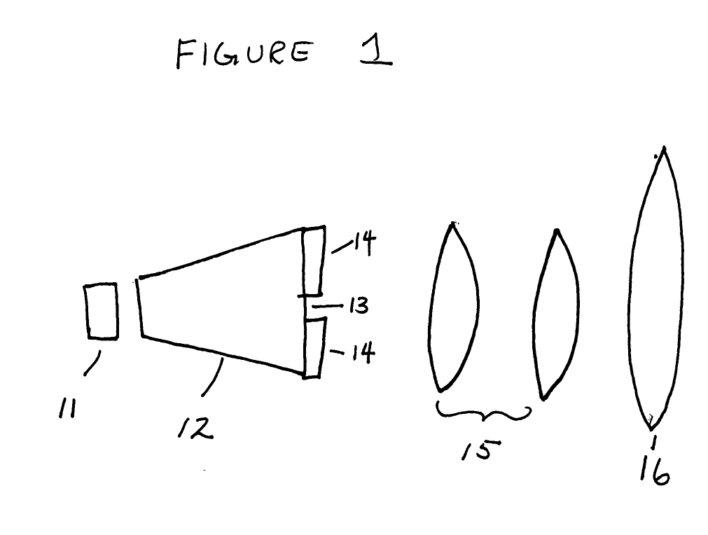

Referring now to the drawings FIG. 1 shows one embodiment of the invention, which is a flashlight that employs light that is emitted by a white phosphor as the light source, configured so that part of the emitted light is recycled to increase its brightness. Output from the system is brought out via a projection lens.

With reference to FIG. 1, a light emitting diode or “LED” 11, such as a white phosphor, a white phosphor that is pumped by an LED, or a laser, is used. Preferably, but not exclusively, the phosphor emits blue, or ultraviolet light.

The LED is coupled to a light pipe “12.” While depicted as tapered, the light pipe may be straight and may be solid or hollow, as required by design choice. At least a portion of the light pipe's interior output surface may be coated with a reflective surface, such that only a portion of outputted light leaves the system resulting from the light pipe and LED, through an aperture “13.” The coating is preferably silver, but may be any wavelength dependent coating. The deployment of coating on the interior may vary dependent upon design choice. The shape of the aperture may vary and can be, e.g., circular, rectangular, square, and so forth. The aperture is formed by a plurality of reflectors “14.”

In a particular embodiment the light pipe interior may be coated via, e.g., painting, where the color coating is chosen so as to enhance a desired color emitted by the LED. For example, a coating that reflects the color blue emitted from the LED enhances recycling of blue light, which thus enhances the projection of other colors.

In a particularly preferred embodiment, the LED comprises a white phosphor which is driven by blue light emitted by the LED. When the light is recycled in the light pipe, recycled blue light is reabsorbed by the phosphor and re-emitted as red and green light. The resulting, recycled light has lower blue output, with concomitant, higher red and greet output.

If a higher power output is desired or necessary, a plurality of LEDs are deployed in combination with one or more phosphor segments, configured so that emitted light can be directed into the light pipe with recycling, and towards lens system 15.

In further embodiments not depicted herein, the outputs from multiple LEDs may be combined using prisms, light pipes, or other means well known in the art, so as to provide waveguides which result in higher outputs at the screen “16”, i.e., the output spot.

The advantages of using light from a white phosphor instead of combining colored LEDs to produce white output light include the fact that the white LED uses a shorter wavelength, larger band gap LED to pump the phosphor, which can then be run at a higher junction temperature, easing the heat-sinking requirement. A single white color LED is used, to eliminate the need for multiplexing multiple colored LEDs to produce the white color. There are also many vendors producing white LEDs. In addition, a large emitting area can be obtained using multiple, smaller blue or UV LEDs pumping a layer of phosphor with a larger area. The final emission area does not have the blank/dark/absorbing seams between the LEDs, which reduces the recycling efficiency.

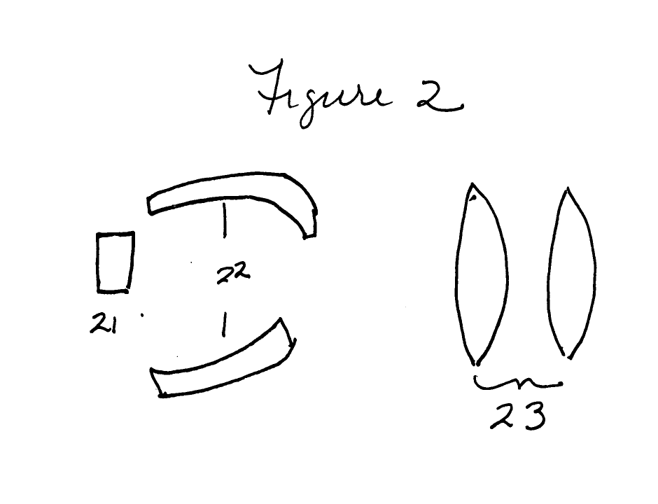

Further embodiments of the invention are seen in the additional figures. FIG. 2 shows an embodiment where a recycling collar 22 is deployed to increase the brightness from the LED or phosphor 21. The light is direct to lens system 23, which may include a plurality of lenses. The lens system collects the light, forming it into a beam, while uncollected light recycles to the LED via the collar 22. The reflected light is recycled for increased output. Optimally, the lens system may be integral with the recycling collar. Especially preferred are systems where the collar and lenses are glass or plastic. In a particularly preferred embodiment, the aforementioned collar is a spherical collar which forms an image of the LED back onto itself, thus completing the recycling process.

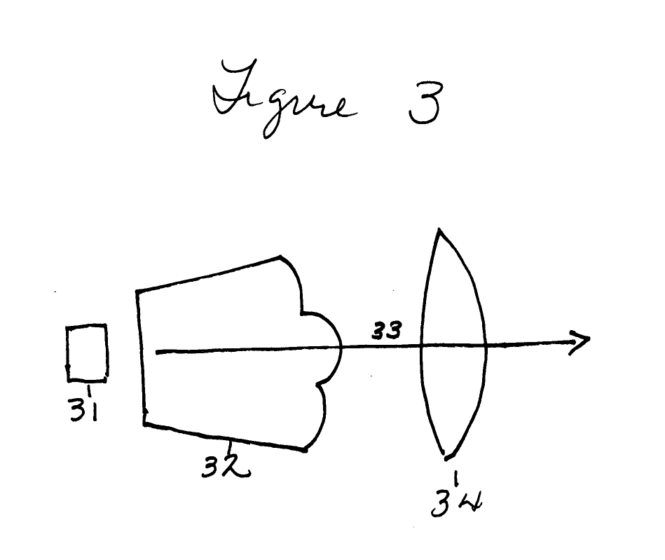

In a further embodiment shown in FIG. 3, the recycling system comprises a single piece construction 32, which is preferably glass or plastic. A portion of light is collimated as an output beam 33, optionally through a lens 34. A portion of light is recycled back to the LED 31, via 32. As with the other systems, the LED may be a colored LED or one covered with white phosphor.

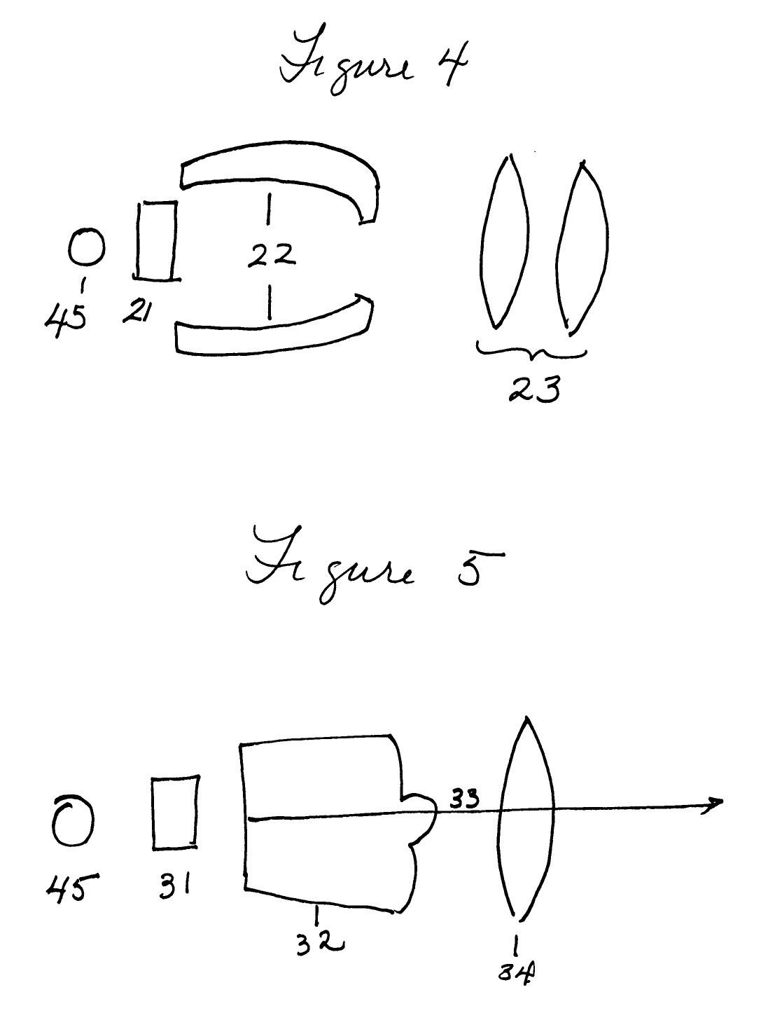

When higher outputs are necessary or desired, a laser is deployed to pump a light emitting phosphor such that light is emitted with higher intensity. FIG. 4 shows an embodiment which parallels that shown in FIG. 2, but for the use of laser 45 in the figure. The same modification can be made to FIG. 3, thus resulting in the embodiment shown in FIG. 5.

Phosphors as used in the embodiments involving lasers may be pumped by lasers which emit wavelengths that are, e.g., blue or ultraviolet, or infra red lasers. The latter tend to be more energy efficient.

Various embodiments of the invention have been described herein; however, the skilled artisan will appreciate that there are various other embodiments, all of which are encompassed herein.

The terms and expression which have been employed are used as terms of description and not of limitation, and there is no intention in the use of such terms and expression of excluding any equivalents of the features shown and described or portions thereof, it being recognized that various modifications are possible within the scope of the invention.

What is claimed is:

1. An illuminator device, comprising:
(a) a light generating means, coupled with
(b) a light directing and reflecting means, said light directing and reflecting means having an output means for releasing a portion of light generated by (a)
(c) at least one lens.

2. The illuminator device of claim 1, wherein (a) is a light emission device (LED).

3. The illuminator device of claim 2, wherein said LED comprises a white phosphors.

4. The illuminator device of claim 1, wherein (b) is a light pipe.

5. The illuminator device of claim 4, wherein said light pipe is tapered.

6. The illuminator device of claim 4, wherein said light pipe is straight.

7. The illuminator device of claim 4, wherein said light pipe is hollow.

8. The illuminator device of claim 4, wherein said light pipe is solid.

9. The illuminator device of claim 4, wherein said light pipe is at least partially coated on its surface with a reflective material.

10. The illuminator device of claim 1, wherein (b) is a light collar.

11. The illuminator device of claim 10, wherein said light collar is spherical.

12. The illuminator device of claim 2, wherein said LED emits blue light.

13. The illuminator device of claim 2, comprising a plurality of LEDs.

14. The illuminator device of claim 13, further comprising a plurality of waveguides.

15. The illuminator device of claim 14, wherein said waveguides are prisms or light pipes.

16. The illuminator device of claim 1, further comprising a laser.
